(19) United States
(12) Patent Application Publication
(10) Pub. No.: US 2011/0239372 A1
(43) Pub. Date: Oct. 6, 2011

(54) Personal support device that provides uniform distribution of pressure on a body portion

(76) Inventors: Nikhil Bhat, Fremont, CA (US); George Yoseung Choi, Menlo Park, CA (US)

(21) Appl. No.: 13/065,877

(22) Filed: Mar. 30, 2011

Related U.S. Application Data
(60) Provisional application No. 61/341,464, filed on Mar. 31, 2010.

(51) Int. Cl. A61G 7/07; A47C 16/00; A47C 27/10

(52) U.S. Cl. 5/690; 5/652; 5/655; 5/655.4; 5/655.5; 5/655.3

(57) ABSTRACT

Embodiments of the technology provide a personal support device for provision of therapeutic support to a portion of a body resting thereon and methods associated with the device. Device embodiments include a substrate having an array of pressure-distributing element host sites, and a population of volumetrically-incompressible pressure-distributing elements at the host sites to form an array of pressure-distributing elements. A therapeutic surface overlays the pressure-distributing elements, and provides an interface between the array of pressure-distributing elements and an aspect of the body portion in contact with the therapeutic surface. The device is configured to form a supportive site within the therapeutic surface that is conformative to the aspect of the body portion in contact with the therapeutic surface when the body part is lying thereon. The supportive site is further configured to apply a substantially uniform distribution of pressure against the aspect of the body part in contact with the supportive site.

### CROSS-REFERENCE TO RELATED APPLICATIONS

This application claims priority to U.S. Provisional Patent Application No. 61/341,464 of Bhat and Choi, entitled “Therapeutic pillow and method for prevention and treatment of positional deformation of an infant head”, as filed on Mar. 31, 2010.

### TECHNICAL FIELD

The presently disclosed technology relates to devices and methods for treating or preventing positional plagiocephaly and brachycephaly as well as pressure sores.

### BACKGROUND

Positional plagiocephaly and brachycephaly refer to deformation of the developing skull of an infant due to in utero development, trauma, or habitual deforming pressure being exerted on the skull, typically occurring as the infant sleeps in a particular position. Positional or deformational plagiocephaly refers to an asymmetrical shape of the head caused by environmental circumstances, such pressure applied on one side of the back of the head. A plagiocephalic head shape is characterized by a flattening on one side of the back of the head and a noticeably rounder shape on the opposite side. Positional brachycephaly, or flat head syndrome, refers to a condition where the head is disproportionately wide compared to its depth; its cause is considered to be supine sleeping, with the head positioned on a flat surface.

There has been an increase in the frequency of brachycephaly in recent years, with about 1 child in 60 showing signs of the condition. In 1992, the American Academy of Pediatrics launched a “Back to Sleep” Campaign, in an effort to decrease the incidence of Sudden Infant Death Syndrome. The response to this well-intentioned campaign is thought to have led to increasing numbers of children being kept on their backs for extended periods of time, and a consequent increase in the incidence of brachycephaly.

During the initial development, an infant's skull is soft and malleable, allowing the natural head growth. After about 6-7 months, the skull starts to harden and bones start to fuse at fontellas as the head starts to assume a formative shape. Due to increased duration of time when the children are placed on their back, the head is supported by a smaller area, which can lead to the occurrence of localized high-pressure zones. These localized support regions, can cause the development of flat areas or flat zones at the back of the head.

If brachycephaly or plagiocephaly is addressed early enough, when the skull of the child is still growing, it is amenable to various forms of treatment that normalize or correct the range of pressures to which the skull is subjected. Cranial orthoses, such as straps and helmets have met with some success in treatment, but come with the downside of being relatively intrusive into daily activity, and the necessity of having to be worn most hours of the day. Similarly pillows and wedges have been brought into the range of therapeutic options, but are more passive in nature, and may not provide the directness and intensity of treatment as provided by orthoses. Embodiments of the therapeutic pillow and methods of use provided herein offer promise of improving the effectiveness of pillow-based therapy.

### SUMMARY OF THE DISCLOSURE

Embodiments of the technology provide a therapeutic device, more particularly, a therapeutic pillow that is conformable to a portion of an infant's skull, and is adapted to provide a substantially uniform distribution of pressure across the area of the skull that is contact with an embodiment of the pillow. One particular application of the technology is in the treatment or prevention of brachycephaly or plagiocephaly in infants. In some embodiments, the application of pressure may be adjustable. Embodiments of the therapeutic device typically rely on gravitational force as the prevailing form of force exerted between an infant's head and the therapeutic device, and typically do not make use of an actively applied force, as could be exerted by straps, restraints, or the like. Benefits of a substantially uniform distribution of pressure include the providing of an opportunity for the skull to take its most natural developmental form, free of external pressure bias.

Embodiments of the technology also include methods for treating or preventing positional-based deformational growth on an infant skull such as manifests in brachycephaly or plagiocephaly. The use of embodiments of a therapeutic pillow, as provided herein, is typically appropriate for an infant up to about 2 years of age, when the skull is growing, and before bones of the skull have fused. Treatment of positional deformation may be understood to include prophylactic or preventive treatment as an advantageous course for an infant is to avoid the onset of any deformational development. The use of embodiments of the therapeutic pillow provides no risk of overcorrection or harm; it can only encourage appropriately proportioned growth of an infant skull. Embodiments of the therapeutic pillow may also be understood as an aid to healthful sleep, encouraging the onset of sleep, its continuity and all the physical and mental benefits associated with restful sleep. In a practical sense, these sleep hygiene-related benefits of the therapeutic pillow and the prophylactic effect of discouraging deformational skull growth may occur at the same time.

More generally, as elaborated below, embodiments of the disclosed technology take the form of personal or body support devices or structures that support either a particular part of a body, or a portion of a body, or the body as a whole. Embodiments of the technology provide a dynamic conformable concavity, which moves or relocates in real time, and which provides a substantially even distribution of pressure at the interface between the body and the personal support structure. One particular advantage of the disclosed technology is that body movement is generally not constrained, as the technology does not typically make use of straps or any non-gravitational constraint. This general consideration notwithstanding, embodiments of the technology may include its combination with constraining or restraining mechanisms.

In addition to prevention of positional plagiocephaly and brachycephaly, embodiments of the technology advantageously support sleep hygiene in subjects. Infants may suffer from sleep disorders such as parsomnias and dyssomnias, and these conditions may be ameliorated by the use of aspects of the disclosed technology. In addition to having therapeutic application in infants, embodiments of the device may be therapeutically beneficial for individuals of any age, particularly when therapeutic benefits are considered to include aspects of sleep hygiene, or aspects of healthful benefit for any subject who is bedridden.

In another aspect, embodiments of the technology can provide pressure relief to portions or sites in the body that are at risk for incurring pressure-induced damage. For example, subjects who recuperating from an injury or a surgery, may benefit from a substantially equal distribution of pressure on body parts, rather than a focused pressure point, as may occur, for example, at body joints. Some other subjects who may derive therapeutic benefit from embodiments of the technology may include those who have diseases associated with the musculoskeletal system, such as torticollis. Subjects who face long term or indefinite periods of time in bed, or in wheel chairs may benefit from personal support structures that embody aspects of the disclosed technology. Elderly bedridden subjects are at particular risk of pressure sores for having thinning skin, and for having a diminished muscle tone that lowers the level of movement either during sleep or when the subject is awake. Subjects of any age who suffer from disordered sleep may further benefit from use of the technology.

However, embodiments of the technology take forms beyond that of a pillow. Any personal or body supportive structure used in daily activity may benefit from aspects of the technology. Examples of embodiments include mattresses, chair seats, chair arms, leg support devices, benches, floor mats, or any structure that upon which a subject applies weight, or which habitually encounters part of the body. Embodiments may be useful in the home, in public spaces, in health treatment sites, and in transporting vehicles.

A first group of embodiments of a therapeutic device for prevention or treatment of positional-based deformational growth of an infant's head includes a bottom layer, a contiguous inflatable layer overlaying the bottom layer, a pressure-pad layer overlaying the inflatable layer, and a top cover layer overlaying the pressure pad layer. Although described in the context a device for therapeutic support of an infant's head, any device described herein may also be understood more generally as a device for the therapeutic support of a body part of portion, and for the use of a person or animal of any age. In some embodiments, the pressure pad layer may include a plurality of substantially non-compressible pressure-focusing elements. These embodiments are adapted to be conformable to a portion of an infant's head such as a dorsal portion, and to provide uniformly distributed pressure across an area of contact between the infant's head and the therapeutic pillow. Some examples of these embodiments are depicted in FIGS. 3A-9.

The top cover layer may be understood to comprise a therapeutic surface or therapeutic surface area that comes into contact with the infant's head, and provides therapeutic support. In a pillow as an example, the therapeutic surface may refer to the substantial entirety of either side of the pillow. “Therapeutic surface area” may also generally refer to the area in specific quantitative terms, as for example, a pillow with side dimensions of 30 cm×30 cm could have a therapeutic surface area of 900 cm².

In these embodiments, the pressure-focusing elements may form a height of about 0.5 mm to about 1 cm above an external surface base of the pressure pad. Embodiments of the pressure elements may be arranged in various patterns, such as a two dimensional punctated pattern, or a mountain and valley pattern. In some embodiments, a flexible base sheet may support the pressure elements. In some embodiments, the pressure elements create regions of substantial incompressibility embedded within the pressure pad layer. In some embodiments, the pressure-focusing elements take the form of beads free floating within a fluid of the inflatable layer.

In some embodiments, the inflatable layer may be filled with an inflating fluid medium such as liquid, a gas, or a gel. In these embodiments, the inflatable medium is typically filled to a pressure level sufficient such that no substantial portion of the inflatable layer is collapsed when it receives the weight of the infant's head. In some embodiments, the inflatable layer is segmented into compartments by the inclusion of compartment dividers such as baffles.

In some embodiments, the inflatable layer and the pressure pad layer are integrated into a single layer. In other embodiments, the base layer includes a pocket, and wherein the inflatable layer is sized and configured to be accommodatable within the pocket.

In some embodiments, the inflatable layer has a substantially uniform thickness across its surface area, ranging from a central portion to a peripheral portion. The inflatable layer may have a thickness that ranges from about 5 mm to about 3 cm. The therapeutic pillow may have a two dimensional profile of a size that varies from about 10 cm×10 cm to about 70 cm×70 cm.

In some of these embodiments of a therapeutic device for prevention or treatment of positional-based deformational growth of an infant's head, an inflatable layer hosts a population of pressure-distribution elements dispersed or suspended within the inflatable medium, generally a liquid medium. FIG. 8 shows an example of this embodiment.

In some of these embodiments of a therapeutic device for prevention or treatment of positional-based deformational growth of an infant's head, a substantially porous layer hosts a population of substantially non-compressible pressure distribution elements. FIG. 9 shows an example of this embodiment. Substantially non-compressible elements are described further below in the context of arrayed embodiments of the technology.

Some embodiments of the technology provide a method for preventing or treating positional deformational development of an infant's head. The method includes supporting the head of a supine infant on an embodiment of a therapeutic pillow as summarized above.

In various embodiments of this method, supporting the head includes of taking advantage of gravitational force to the exclusion of any supplementary force as applied by a form of physical restraint or application of pressure. In typical embodiments of the method, supporting the head of the supine infant includes contacting a dorsal portion of the head against the pillow. In typical embodiments of the method, wherein supporting the head of the supine infant includes contacting in the range of about 5% to about 75% of the surface area of the head against the pillow. In some embodiments of the method, supporting the head of the supine infant includes distributing pressure exerted by the pillow against the head with substantial uniformity across a surface area of the head in contact against the pillow. In further embodiments, supporting the head of a supine infant on a therapeutic pillow comprises the pillow forming a cavity that conforms to a dorsal portion of the infant's head.

Embodiments of the method may further include inflating an inflatable layer of the pillow with a liquid or a gas to a pressure sufficient such that no substantial portion of the inflatable layer is collapsed when it receives the weight of the infant's head. Some embodiments of the method may further include applying pressure at focal points associated with the pressure elements.

A second group of embodiments of a personal support device for provision of therapeutic support of a portion of a body include a layer or substrate having an array of pressure-distributing element host sites, a population of volumetrically-incompressible pressure-distributing elements disposed at the arrayed host sites to form an array of pressure-distributing elements, and therapeutic surface overlaying the pressure-distributing elements, the therapeutic surface positioned to interface between the array of pressure-distributing elements and an aspect of the body portion in contact with the therapeutic surface. In these embodiments, the device is configured to form a supportive site within the therapeutic surface, the site being conformative to the aspect of the body portion in contact with the therapeutic surface when the body part is lying thereon, the supportive site being further configured to apply a substantially uniform distribution of pressure against the aspect of the body part in contact with the supportive site. Examples of embodiments of this group of embodiments wherein pressure distributing elements are disposed in an array are shown in FIGS. 10A-13B, and described further below.

In some embodiments, the supportive site may be configured to be relocatable within the therapeutic surface area in response to movement of the body portion. In these embodiments, the site is configured to remain conformative to the aspect of the body portion with which it is in contact, and to maintain a substantially uniform distribution of pressure against the aspect of the body portion with which it is in contact as the site relocates. Embodiments of the supportive site are typically concave in broad aspect, but more they conform more particularly to the body portion resting on the device.

The supportive or concave site is a stable feature as long as the body portion resting on it is not moving. However, the supportive site is relocatable, and thus may also be a positionally transient or temporary feature. However, even as a transient feature, it maintains its conformance to the body portion while the body portion is shifting or relocating, and it maintains a substantially equivalent distribution of pressure across the surface area of the body portion in contact with the therapeutic surface even as the body portion is shifting or relocating.

Embodiments of a personal support device may have one or more therapeutic surface areas; for example in an embodiment shaped as a standard bed pillow, one or both of the broad surfaces of the pillow may serve as therapeutic surfaces area. If the device has a more complex configuration, there may be more than two therapeutic surfaces, as for example, a triangular wedge-shaped device. In still other embodiments, a therapeutic surface is not necessarily flat, as for example a portion or the entirety of the surface of a cylindrical-shaped personal support device.

The overall size, shape, and configuration of embodiments of the personal support device can vary depending on the body part or portion that is intended to be therapeutically supported. For example, if an infant is showing signs of positional head deformation, an appropriated device embodiment may be sized, shaped, and configured as a pillow dimensioned for an infant. If a subject is at risk for developing a pressure sore, or already has a pressure sore in need of treatment, a device embodiment may be sized, shaped, and configured to appropriately support the portion of the body having the pressure sore, or at risk of developing such. In some instances, full body support is desired, either for treatment or prevention of pressure sores, or for general sleep hygiene. For these purposes, an embodiment of a personal support device may be sized, shaped, and configured as a full body mattress, or as a pad that may be laid over a conventional mattress.

The arrayed embodiments of volumetrically-incompressible pressure-distributing elements are substantially responsible for formation of the relocatable conformative site that distributes pressure uniformly against the surface of the body portion that is resting on embodiments of the device. Some embodiments of the device have a single layer of arrayed pressure-distributing element hosting sites with a population of pressure-distributing elements at the arrayed host sites; other embodiments have a plurality of such layered arrays. With regard to multi-layered embodiments, the layers in some embodiments may be aligned with each other, such that pressure-distributing elements may appear to be stacked directly on top one another. In other multi-layered embodiments, the pressure-distributing elements are not directly aligned with each other, and may appear as staggered with respect to each other.

In some embodiments of a personal support device, the pressure-distributing elements are attached to arrayed host sites, as for example by annealing, or by gluing, or by any method that satisfactorily affixes the elements to an array of sites disposed on or within a supporting substrate or layer, or between layers. In some embodiments of a personal support device, the arrayed pressure-distributing elements take the form of a population of fluid-filled cellular spaces or cells, whose surrounding membranes may be understood either as common membranes or membranes immediately adjacent to each other. Thus, in contrast to other embodiments, these particular embodiments do not have a structural framework per se that forms host sites, or is distinct from the pressure-distributing elements themselves.

In some embodiments of the personal support device, the layer of arrayed pressure-distributing element hosting sites includes a structural framework that provides or defines cellular spaces or voids within the framework, and embodiments of the volumetrically-incompressible pressure-distributing elements are disposed within these cellular spaces. Embodiments of a framework may also be referred to as a matrix or substrate. Embodiments of the framework may be formed with an elastomeric composition such as stretchable rubbers such as silicone or plastics such as vinyl, although in some embodiments the framework may be formed from non-elastic or substantially non-elastic materials. Cellular spaces or voids within the framework are typically arranged in an ordered array or pattern. However an ordered arrangement is not necessary, and in some embodiments the array may be random or irregular, or include regions of disorder. Examples of ordered arrays include patterns wherein the cellular spaces of the framework are arranged in an area-filling or volume-filling patterns. In terms of the shape of cellular spaces, examples of a lateral cross sectional profile of a shape may include any of circular, ovoid, or polygonal. Examples of the three-dimensional form of cellular spaces may include, any of spheroidal, cubic, or polyhedronal.

Particular embodiments of the arrayed pressure-distributing element hosting sites are arranged at an area density of between about 0.1 site/cm² and about 1 site/cm², although the area density of host sites in other embodiments may be either lower or higher than this representative range. As summarized above, arrayed host sites may take the form either of attachment sites within a layer or substrate, or may take the form of discrete cellular spaces within a structural framework.

In some embodiments, the arrayed pressure-distributing element hosting sites have a substantially homogeneous area density throughout the array. In other embodiments, the arrayed pressure-distributing element hosting sites have regions of heterogeneous area density within the array.

Examples of embodiments of pressure-distributing elements include solid bead-like forms and fluid-filled elements, generally spheroidal in shape. Bead-like forms are also typically spheroidal, are hard, smooth-surfaced, and substantially incompressible. These features generally support a free-flowing or freely-rearrangeable quality. Solid-form pressure-distribution elements are typically included as a population within a population of containers, as summarized further below.

In particular embodiments, the volumetrically-incompressible pressure distributing elements include or contain a volumetrically-incompressible flowable composition; typically the pressure distribution elements are sealed such that the flowable composition cannot flow between pressure-distributing elements.

Pressure distribution elements in the form of fluid-filled spheroids are typically filled with a liquid composition such as water, which may further include solutes or other miscible liquids. Liquids may also include organic fluids or gel compositions. The spheroidal shape of fluid-filled pressure elements is not a required shape, but generally one that follows from the unconstrained shape of fluid-filled containers having a skin or membrane with a substantially homogeneous structure, composition, and thickness. Some embodiments of fluid-filled pressure-distribution elements, however, may have a skin or membrane that includes regions with particular features that vary in composition, structure, or thickness. By virtue of the incompressibility or substantial incompressibility of fluids included in the pressure distribution elements, the pressure distribution elements themselves are volumetrically incompressible or substantially incompressible. In contrast to these just described embodiments, other embodiments of the fluid-filled spheroids may be at least partially compressible by virtue of inclusion of a gas composition included therein.

In some embodiments of the personal support device, the population of pressure-distributing elements or fluid-filled spheroids disposed within or host spaces within the framework (or at host sites) is substantially homogeneous in size, structure, and composition. In other embodiments, the population of fluid-filled spheroids may be heterogeneous with respect to any of size, structure and/or composition. In typical embodiments of the personal support device that include a framework structure that provide cellular spaces, the population of pressure-distributing elements is distributed into the cellular spaces such that each cellular space is occupied by one pressure-distributing element. However, in some embodiments, the population of pressure-distributing elements may be distributed into the cellular spaces such that some cellular spaces may not necessarily house a pressure-distributing element, and some cellular spaces may house more than one pressure-distributing element.

Although embodiments of the fluid-filled pressure-distribution elements are volumetrically incompressible, they are configured to be sufficiently compliant so as to be partially flattenable when subjected to the weight of a body part lying on the therapeutic surface. By virtue of the quality of their elastomeric cover or skin, they are further sufficiently resilient so as to be able to return to their native spheroidal shape upon relief from a flattening pressure. When the fluid-filled pressure-distribution elements are included within a cellular space, per embodiments of the technology that include a framework, the expansion of their diameter upon flattening may be constrained by the diameter of the cellular space. Accordingly, to express the dimensional relationship conversely, the diameter of containers holding fluid-filled spheroids is typically sized such that their diameter does constrain the lateral expansion of the fluid-filled spheroids as they are flattened by vertically-applied pressure. When fluid-filled pressure-distribution elements are attached to hosting sites (i.e., not disposed within a framework), per embodiments of the technology, the expansion of their diameter may be constrained by the proximity of their neighboring pressure-distribution elements. By either mechanism of diameter expansion constraint, such constraint also provides a limit to the flattening or reduction in height when the pressure-distribution elements are being subjected to impinging pressure from a body portion lying on the therapeutic surface of the device. The reduction in height upon compression may be in the range of approximately 5% to about 95% of the uncompressed height. The reduction in height of embodiments of the fluid-filled spheres inversely corresponds to the expansion in diameter.

As a portion of a body rests on an embodiment of the personal support device, the area of contact between the resting body portion and the therapeutic surface defines an area where portions of the population of fluid-filled pressure distribution elements are being subjected to pressure, and thereby being flattened, or having their height compressed as a result. Further, within that pressured population of fluid-filled elements, regions of elements are compressed or flattened to varying degrees. For example, regions subjected to greater pressure are more flattened, while those subjected to lesser pressure are flattened less. The variation in degree of flattening of the fluid-filled elements is substantially responsible for forming a conformative site that supports the body portion at the area of contact.

The individual fluid-filled pressure distribution elements, albeit affected by impinging pressure from the weight of a body portion resting on the therapeutic surface directly above, are also affected by the sum of pressures laterally impinging from their neighboring fluid-filled pressure-distribution elements. Thus, by virtue of the collective effects of body weight pressure and lateral pressure on the individual fluid-filled pressure-distribution elements, the whole of population of fluid-filled elements acts collectively as a fluid-like supportive substrate or medium. Further still, the lateral constraints provided by the framework and/or the fixed nearest neighboring elements, prevents over-extended lateral expansion of the fluid, which would allow a bottoming out and loss of underlying fluid support in a central area of the conformative site. Thus, by the combination of these features of the technology, pressure directed toward the supported body portion within the confines of the conformative site is substantially evenly distributed.

In some embodiments of the personal support device, the supportive site includes or encompasses a region within the therapeutic surface that overlays a plurality of pressure distributing elements that cooperate to conform to a body portion laying on the therapeutic surface. In one aspect, the relationship whereby the supportive site is formed from a plurality of pressure-distributing elements follows from the pressure distributing elements being relatively small compared to body portion dimensions. In a related expression of this relationship, it may be understood that a supportive site is generally not formable within the boundaries of a single pressure distribution element. Other aspects of the plurality of pressure-distributing elements being associated with a single supportive site relate to the lateral interaction among neighboring pressure-distributing elements. Thus, in some embodiments, the pressure distribution elements may be positioned in sufficiently close proximity to each other such that when pressure impinging on a first pressure-distribution element is sufficient to cause compression of the height of the pressure distribution element, such height compression is constrained by the lateral proximity of other pressure distribution elements adjacent to the first pressure-distribution element. Further, pressure distribution elements may be positioned in sufficiently close proximity to each other such that when pressure impinging on a first pressure-distribution element is sufficient to cause expansion of a diameter of the first pressure-distribution element, such expansion exerts lateral pressure on other pressure-distribution elements adjacent to the first pressure-distribution element.

Embodiments of the personal support device have an uncompressed or native volume that includes an incompressible portion represented by embodiments of the fluid-filled incompressible pressure distribution elements. The uncompressed volume further includes a compressible fraction as represented by air that can escape during compression, and by solid portions that may be at least partially compressible. The fraction of the native volume of the device that is incompressible may range up to about 90% of the total volume. The fractional height to which a low point of a concave or conformative site within device may be compressed may be as low as 5% of the uncompressed height.

Other features of the compressibility of embodiments of the personal support device include a rapid rate of compression and decompression. Compression and decompression of foam-based devices, for example, involves the efflux and influx of air through foam substrate volume that is impeded to varying degrees by structural aspects of the foam. Compression and decompression of embodiments of the present personal support device is height-based, involving the flattening and recovery from flattening of fluid-filled spheres, which is inherently quicker than impeded movement of air through foam. Further, it may be observed that some foam compositions are temperature sensitive in that their rates of compression and decompression can vary within a range of temperature that includes normal body temperature, while the compression and decompression of height in the presently disclosed technology is substantially unaffected by temperature changes in the range of body temperature.

Embodiments of the disclosed personal support device may include features that allow breathability, or substantially unimpeded movement of air both at the levels close to the surface of the device, and throughout the interior of the device. Breathability can provide safety advantages to the device in that an infant whose face becomes pressed against the surface of the device will not suffocate. Further, a breathable surface allows evaporation of moisture that could otherwise accumulate. Thus, embodiments of an exterior cover of the device may be gas permeable. In some embodiments, a resilient porous layer is provided beneath the permeable exterior that provides a conduit for bulk movement of air. In some of these embodiments, the layer beneath the surface may include a lofting material or substantially incompressible elements that support a space through which air may easily flow. With regard to deeper or interior aspects of the device, some embodiments include channels that communicate between the interior of the device and the exterior surface. Some embodiments of the device have ports positioned on the exterior surface that connect to the interior airflow channels.

Some embodiments of the personal support device of include a peripheral edge support structure of sufficient incompressibility that peripheral edge does not undergo substantial collapse under the weight of the body portion lying in the device. A peripheral edge support may further be sufficiently inelastic that it disallows substantial expansion of the square area dimension of any therapeutic surface when the device is being compressed by pressure from the body portion lying thereon.

Embodiments of the disclosed technology further provide methods for providing therapeutic support to a body portion. In one aspect, the method includes supporting the portion of the body on a therapeutic surface of the personal support device as summarized above. Briefly, such as device includes a layer or substrate having an array of pressure-distributing element host sites and a population of volumetrically incompressible pressure-distributing elements disposed at the arrayed sites to form an array of pressure-distributing elements. The device further includes a therapeutic surface area overlaying the pressure-distributing elements, the therapeutic surface area being adapted and positioned to interface between the of pressure-distributing elements and an aspect of the body portion in contact with the therapeutic surface. The device, as a whole, is configured to form a relocatable conformative or generally concave site within the therapeutic surface area when the body part is lying thereon. The conformative site provides an area of contact between the body part and the therapeutic surface area, and is configured to apply a substantially uniform distribution of pressure against the portion of the body part that is in contact with the conformative site.

In another aspect, a method for providing therapeutic support to a portion of a body includes forming a supportive site within a therapeutic surface that substantially conforms to an aspect of the portion of the body that contacts the therapeutic surface at a first location, and applying a substantially uniform distribution of pressure from the supportive site against the aspect of the portion of the body in contact with the therapeutic surface at the first location. The method may further include relocating the supportive site from the first location to a second location within the therapeutic surface in response to the portion of the body shifting from the first position to a second position, the supportive site conforming to the portion of the body and applying a substantially uniformly distribution of pressure to the aspect of the body portion in contact with the therapeutic surface while the supportive site is relocating. The method may further include conforming the supportive site at its second location to an aspect of the body portion in its second position as it contacts the therapeutic surface at the second location and applying a substantially uniform distribution of pressure to the aspect of the body portion as it contacts the therapeutic surface at the second location.

### BRIEF DESCRIPTION OF THE DRAWINGS

FIG. 1A shows a view of an infant's head on a therapeutic pillow per embodiments of the technology.

FIG. 1B shows a free-body view of an infant's head and forces impinging thereon, as the infant's head is supported on a therapeutic pillow.

FIG. 1C shows a view of an infant's head supported on a conventional support surface.

FIG. 1D shows a free-body view of an infant's head and forces impinging thereon, as the infant's head is supported on a conventional support surface.

FIG. 2A is a schematic drawing of a conformative support site at a first location within a therapeutic surface.

FIG. 2B is a schematic drawing of a conformative support site relocating from a first location within a therapeutic surface to a second location within a therapeutic surface.

FIG. 2C is a schematic drawing of a conformative support site at a second location within a therapeutic surface.

FIG. 3A is a top view of an embodiment of a therapeutic pillow.

FIG. 3B is a side view of an embodiment of a therapeutic pillow.

FIG. 3C shows an exploded perspective view of layers of an embodiment a therapeutic pillow.

FIG. 4 shows a cross-sectional side view of an alternative layered embodiment of a therapeutic pillow.

FIG. 5 shows a cross-sectional side view of another alternative layered embodiment of a therapeutic pillow.

FIGS. 6A, 6B, and 6C show various embodiments of patterned pressure-pads for use in embodiments of a therapeutic pillow.

FIG. 7A shows a perspective view of an embodiment of the therapeutic pillow that includes an air-inflated layer and a port for inflation.

FIG. 7B shows a cross-sectional perspective view of an embodiment of the therapeutic pillow that includes an internal side support.

FIG. 8 shows an embodiment of a therapeutic pillow that includes a liquid-inflatable layer with pressure-distribution elements included therein.

FIG. 9 shows an embodiment of a therapeutic pillow that includes a porous or breathable layer with pressure-distribution elements included therein.

FIG. 10A shows an embodiment of a therapeutic pillow that includes an array of sites to which pressure-distribution elements may be fixed.

FIG. 10B shows an embodiment of a therapeutic pillow that includes an array of one or more layers of tiled pressure-distributing elements arranged in a pattern, each element having a fluid-filled space.

FIG. 10C shows an embodiment of a therapeutic pillow that includes an array of one or more layers of tiled pressure-distributing elements arranged in an alternative pattern, each element having a fluid-filled space.

FIG. 11A shows a top perspective view of an embodiment of a therapeutic pillow that includes an array of cellular spaces in which pressure-distribution elements may be disposed.

FIG. 11B shows an exposed top perspective view of an embodiment of a therapeutic pillow that includes an array of cellular spaces in which pressure-distribution elements may be disposed.

FIG. 12A shows a perspective view of an embodiment of the therapeutic pillow that includes a surface having pressure-focusing elements, and an array of cellular spaces into which fluid-filled pressure distribution elements may be disposed.

FIG. 12B shows an exposed view of an embodiment of the therapeutic pillow that includes a surface having pressure-focusing elements, and an array of cellular spaces into which fluid-filled pressure distribution elements are disposed.

FIG. 12C shows a cross-sectional side view of an embodiment of the therapeutic pillow that includes a surface having pressure-focusing elements, and an array of cellular spaces into which fluid-filled pressure distribution elements are disposed.

FIG. 13A shows a top view of the surface of an embodiment of the therapeutic pillow that includes a surface having pressure-focusing elements as well as pores for breathability between the exterior and interior of the pillow.

FIG. 13B shows a side view of the surface of an embodiment of the therapeutic pillow that includes a surface having pressure-focusing elements as well as pores for breathability between the exterior and interior of the pillow.

FIG. 13C shows a detailed cross-sectional side view of the surface of an embodiment of the therapeutic pillow as shown in FIGS. 13A and 13B, the detail showing fluid-filled pressure-distribution elements disposed within cellular spaces of a matrixed framework.

### DETAILED DESCRIPTION

Embodiments of the disclosed technology provide therapeutic support for portions of the body that benefit from distribution of pressure over the fullest possible area of the body portion that is in contact with the supportive surface. Embodiments of the technology may be advantageously used to support any portion of the body, for example, the head of an infant, or any body portion that includes an underlying bony aspect in close proximity to the body surface. The technology provides a substantially concave supporting surface that is conformable to the body portion and is synchronously reconformable and relocatable as the part of the body shifts. A particular therapeutic application of the technology relates to supporting the head of an infant who has shown signs of a positional deformation of the skull.

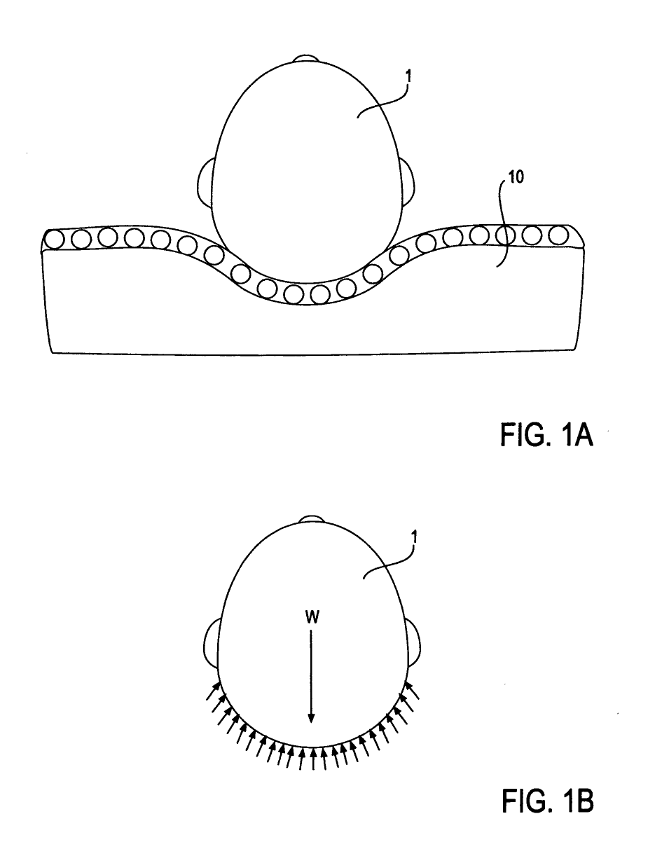

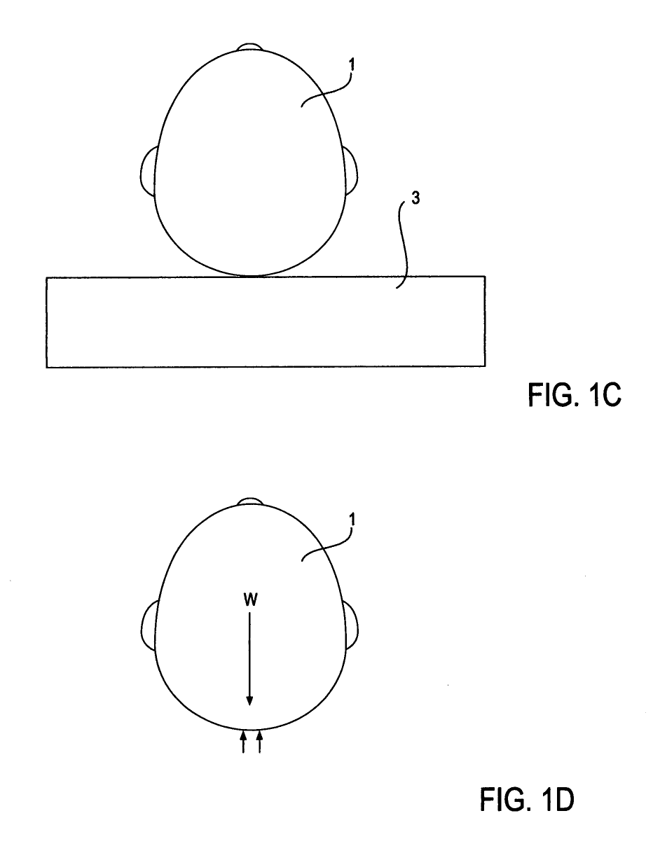

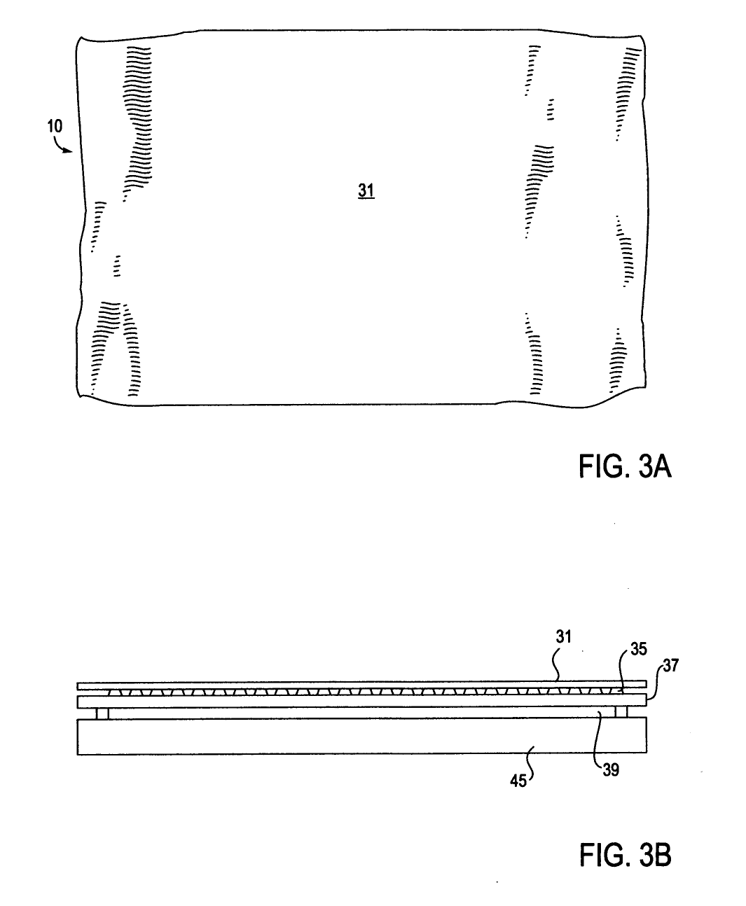

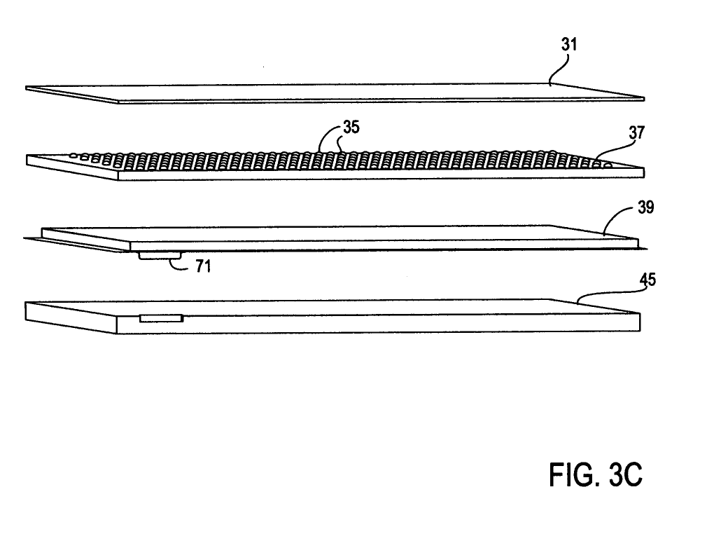

FIGS. 1A-1D show views of a supine infant at rest on an embodiment of the disclosed personal support device, such as a therapeutic pillow (FIGS. 1A and 1B) compared to a supine infant at rest on a conventional surface (FIGS. 1C and 1D), such as a pillow or mattress. Examples of embodiments of the disclosed technology are shown in FIGS. 3-13C.

FIG. 1A shows a side perspective view of an infant's head 1 lying on an embodiment of a therapeutic pillow 10, or more specifically on a therapeutic surface provided by the pillow, per embodiments of the disclosed technology. The conforming nature of contact between the pillow and the head increases the surface area of head-to-pillow contact and tends to make pressure distribution across the contact area uniform. These effects decrease the range of variation in pressure, and substantially diminish the occurrence of areas of focused pressure across the area of head-to-pillow contact that would occur with a conventional pillow or mattress. FIG. 1B shows a free body diagram of an infant head 1 that is in contact with an embodiment of the pillow 10 in a manner such that pressure is being uniformly distributed across the portion of the head in contact with the pillow, even as the center of gravity W of the head is vertically directed downward.

FIG. 1C shows an infant lying with his or her head 1 on a conventional mattress 3. FIG. 1D provides a free body diagram of the head 1 is in contact with the mattress 3. As may be seen from the free body diagram, a relatively small area of contact at the back of the head supports the downward directed weight W of infant head 1. Accordingly, a focused area of high pressure occurs at the contact area. When a sleeping arrangement such as that depicted in FIGS. 1C and 1D becomes habitual, the infant is at risk of developing brachycephaly, or flat-head syndrome. In contrast, an infant sleeping on a therapeutic surface such as that shown in FIGS. 1A and 1B is protected from development of brachycephaly.

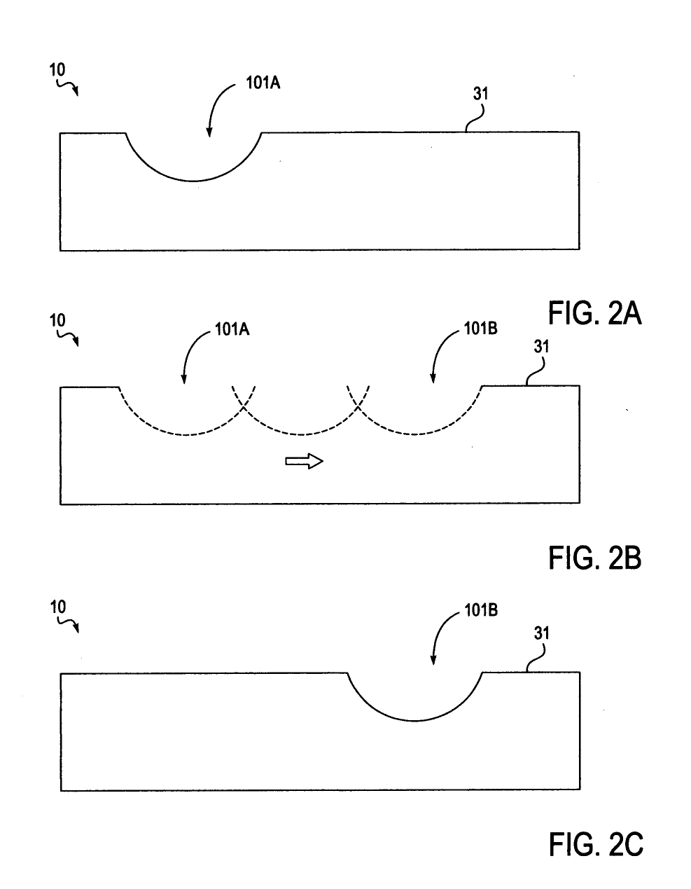

FIGS. 2A-2C are schematic representations of a relocation of a conformative support site 101A in a first location to a second location 101B on a therapeutic surface 31 of a personal support device 10. FIG. 2A shows the conformative support site at a first location, FIG. 2B shows the conformative site in the process of relocating from the first location to a second location, and FIG. 2C shows the conformative support site 101B at the second location. This relocation occurs in response to a shift in the position of a body portion from a first position to a second position (body portion not shown). The conformative support site, both at positions 101A and 101B, and during the relocation from the first location to the second location, continuously conforms to the aspect of a body portion contacting the therapeutic surface 31, and continuously applies a uniform distribution of pressure against the surface of the body portion.

Some embodiments of the inventive therapeutic pillow may have multiple layers with a top layer or cover that includes a skin contact-friendly material for contact with an infant's head, typically the back of the infant's head, as the infant is lying supine in bed. Layered embodiments of the technology are shown in FIGS. 3A-5. A contact-friendly top layer may be underlain by a pressure-pad layer that is flexible, and may include an array or pattern of pressure-focusing elements that are structurally embedded in a portion of the pillow.

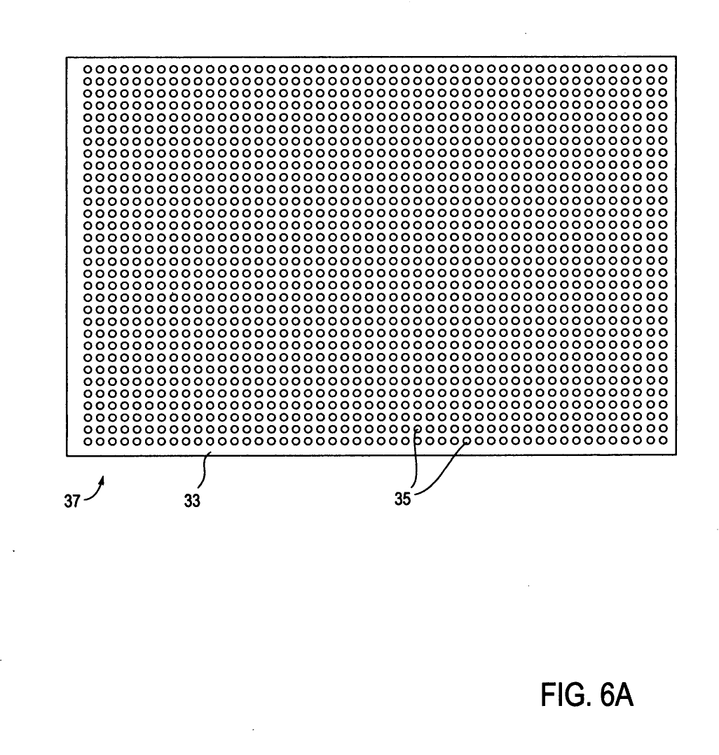

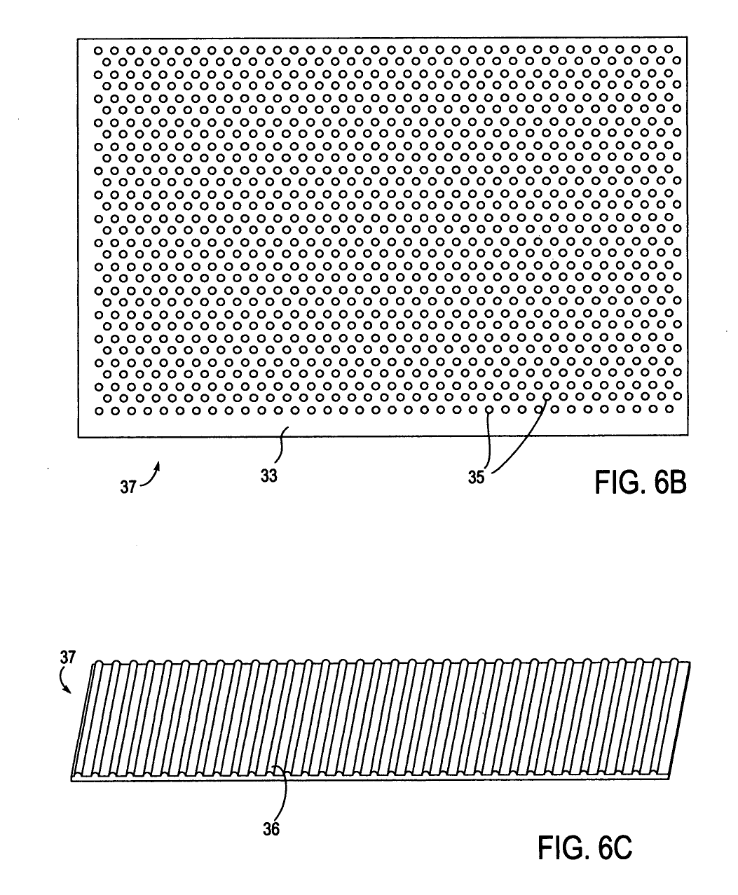

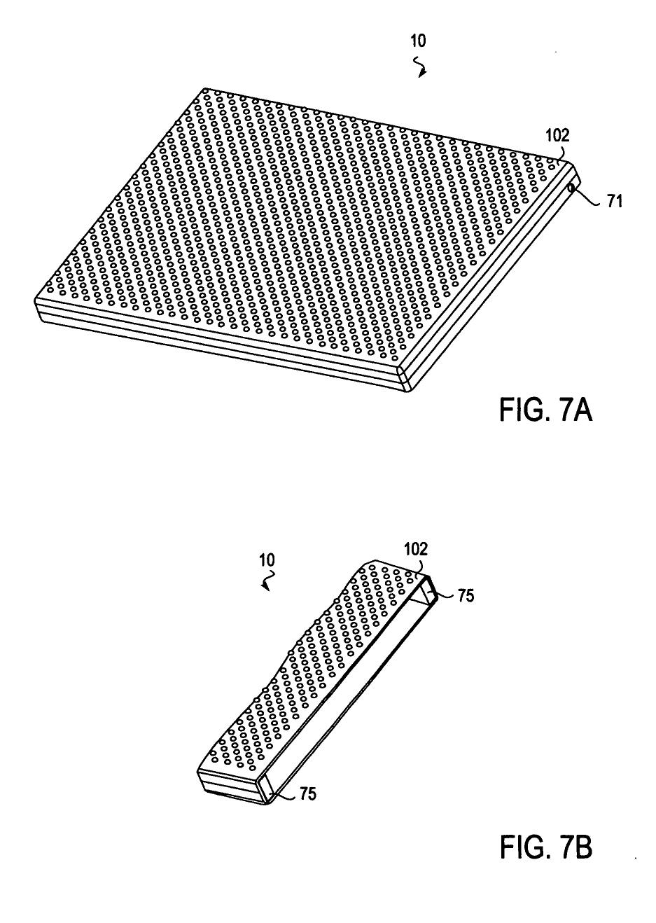

Embodiments of patterns of pressure-focusing elements are shown in FIGS. 6A-6C, and embodiments of a therapeutic support device that incorporate such pressure-focusing elements are shown in FIGS. 7A, 7B, and 12A-13C. These pressure elements may impart a therapeutic benefit, such as providing acupressure effects that may provide generally healthful benefits, such as restful sleep, or acupressure effects may specifically encourage growth of the infant skull in a form that is broadly encouraged by the conformational support provided by embodiments of the therapeutic pillow as whole. The pressure-element pattern may be molded on the fluid-pad.

Some embodiments of a pressure-pad layer may be underlain by an inflatable fluid-pad layer that provides a substantially uniform pressure across the entire contact area between the pillow and the head, thus minimizing the occurrence of localized pressure zones on the back of the head. The inflatable pad may be filled with any suitable fluid, including a gas (such as room air) or a liquid, such as water. Other liquids or solution may be used, and the viscosity of such liquids may be adjusted for an optimal therapeutic effect. Embodiments of the technology that include a layer inflatable with a liquid include those shown in FIGS. 3B-5, and 8. Embodiments that include a layer inflatable with a gas such as air, include those shown in FIGS. 7A and 7B. Embodiments of the therapeutic pillow, as a whole, are conformable, and compliantly form a cavity to accommodate the infant's head. In some embodiments of the therapeutic pillow, an inflatable fluid-pad and a pressure-pad layer are integrated, as shown in FIG. 5. This integrated fluid-pad pressure-pad layer may be disposed between two soft layers of foam or other compliant and suitable material.

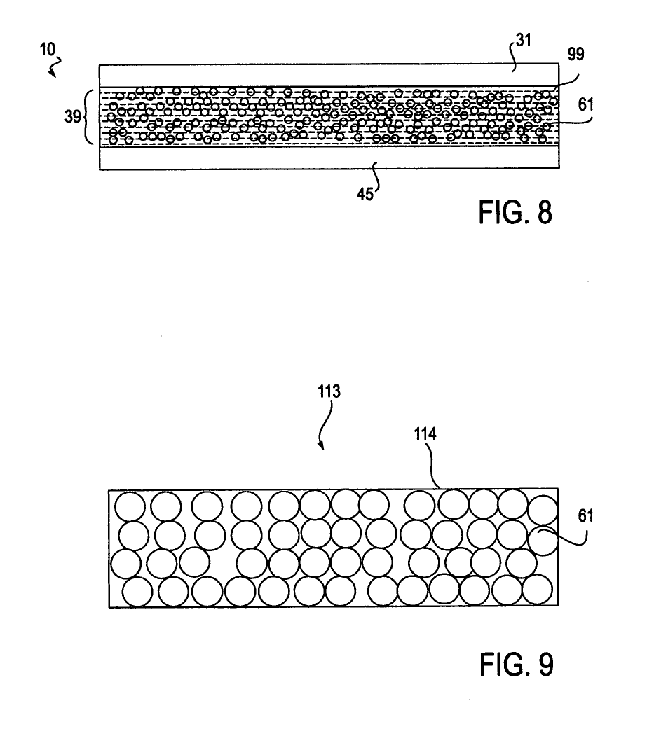

In some embodiments of the therapeutic pillow, as shown in FIG. 8, pressure-distributing elements may suspended in an inflatable fluid-pad containing fluid. Pressure-distributing elements may also be disposed between two soft foam layers. In other embodiments, as shown in FIG. 9, pressure-distributing elements may be contained within a porous compartment. When an infant sleeps on the pillow, the weight of the head causes the beads to rearrange around the spherical region of the head in contact with the pillow while the fluid provides the pressure to uniformly support the head in that shape.

The various embodiments of the therapeutic pillow are generally formed or adapted to allow conformability to an infant's head. When an infant's head rests on the pillow, the fluid in the inflatable fluid pad displaces to support the surface area of the head with which it is in contact. Pressure-focusing elements of a patterned pressure-pad, such as relatively incompressible portions of the pressure pad may act as acupressure points for the head. The pressure in the pillow may be adjusted by controlling the amount and/or pressure of fluid in the inflatable pad portion of the pillow. The pattern of the pressure beads and the distance between adjacent beads is configured for maximum contact of the head surface. The configuration also prevents any interference between adjacent pressure points when the head is resting on the pressure pad. The gap between the pressure points is proportioned such that surface-to-surface contact with the head is maximized, and when the head and the pressure pad are in contact, the pressure pad conforms to the head. The gap and the pattern of the pressure points are further configured such that adjacent pressure elements do not interfere with each other.

In another aspect, embodiments of the therapeutic pillow may be understood as devices that provide a passive engagement with the infant's head. These embodiments have no restraints on the infant's body in general, nor any restraints or fasteners that actively engage the device to the infant's head. The pressure exerted by the infant's head on an embodiment of the therapeutic pillow consists only of the force of gravity, and similarly, the pressure exerted by the pillow on portions of the infant's head, derives solely from gravity.

Some dimensions and various force or pressure parameters associated with the technology will now be provided to further an understanding of the disclosure. For the sake of an example, consider the circumference of a boy's head at birth to be around 31.6 cm and the weight to be about 523 gms. If the head is assumed to approximately spherical in shape, the head radius is about 5 cm. If 10% of total head surface area (31.4 cm²) is in contact with the pillow, the supporting pressure applied by the pillow is 1.64 N/mm². In contrast, if the head is resting on a conventional non-therapeutic pillow or a mattress, a much smaller surface area is in contact with the underlying support surface (pillow or mattress). If, for example, 2.5% of the head surface area (7.85 cm²) is in contact with a conventional non-therapeutic pillow, the supporting pressure applied by the conventional non-therapeutic pillow is 6.54 N/mm², a three-fold increase in pressure impinging on skull surface. Thus, through the use of a pillow of the technology, pressure can be distributed over a wider surface area and a positional deformation of an infant's skull can be prevented or treated.

Some embodiments of the technology, as in the first group of embodiments summarized above, variously include pressure-focusing elements, pressure-distribution elements, and inflatable layers. Examples of these embodiments are shown in FIGS. 3A-9, as described in detail below.

FIGS. 3A-3B show various views of layered device embodiments of the technology. FIGS. 3A and 3B show a top view and a cross-sectional side view, respectively of an embodiment of the therapeutic pillow 10. A top view, as shown in FIG. 3A, shows a therapeutic surface 31 as provided by a therapeutic pillow. In some embodiments of the technology, a single side of a pillow comprises a therapeutic surface, and in other embodiments, both sides may comprise a therapeutic surface. Some embodiments of the pillow may have a length ranging from about 10 cm to about 70 cm, and a width ranging from about 10 cm to about 70 cm; one particular embodiment has a length of about 30 cm and a width of about 20 cm.

This particular example of a pillow embodiment has a multilayered design, with soft foam or any other suitable and compliant material forming a top layer or therapeutic surface 31 and a bottom layer 45. When in use, the top layer is in contact with the infant's head, while the bottom layer is in contact with the underlying bedding or mattress. The layers may include materials such as cotton, polyurethane foam, polystyrene foam, or memory foam. These layers can vary from about 1 mm to about 10 mm in thickness. The layers 31 and 45 can also be part of a single composite soft case that encloses the other parts of the therapeutic pillow.

Adjacent to the top layer or therapeutic surface 31 is a pressure-pad layer 37. This pressure-pad layer 37 comprises a patterned layer with a plurality of pressure-focusing elements 35, such as pressure-beads or pressure points, disposed or arranged in a pattern on or within layer 37. This pressure-pad layer 37 is typically a molded flexible plastic or rubber material. The thickness of the pressure-pad layer 37 may range from about 1 mm to about 15 mm; in a particular embodiment the pressure pad layer has a thickness of about 5 mm. The pressure pad is configured to provide uniformly spaced pressure-focusing elements for the head to rest on. The pressure-pad is also configured to be sufficiently flexible to conform to the shape of the head when the infant's head is in contact with the pillow. Varied configurations of pressure-pad 37 are described below.

An inflatable fluid-pad layer 39 is disposed between the pressure-pad layer 37 and the bottom layer 45. This embodiment of a fluid-pad 39 is similar to an enclosed-bag or a flat balloon filled with fluid. The fluid layer 39 provides uniform pressure around the head surface area when the infant's head is in contact with the pillow. The inflated fluid-pad layer 39 can vary in thickness from about 5 mm to about 25 mm; in a particular embodiment, the thickness is about 15 mm. Any suitable fluid or gel may be used as the fluid in the fluid-pad, such as water, air, oils, or gels such as silicone gel. The material from which the inflatable fluid-pad is fabricated may include soft and stretchable polymers, such as silicones and urethanes. The material of the fluid-pad may also include non-stretchable or low-stretch materials such as vinyl and other types of polymers. As described further below, embodiments of the fluid pad layer may include baffles that connect the upper and lower surfaces to prevent ballooning or bottoming out of the pad.

When an infant's head rests on therapeutic pillow 10, depending on the weight of the head and the volume and pressure of fluid in the fluid pad 39, a variable fraction of the surface area of head will be in contact with the pillow 10. The pressure-beads or pressure points 35 present in the pressure-pad 37 conform to the shape of an infant's head, providing uniform pressure points around the back of the head. In general, the conforming nature of contact between the pillow and the head increases the surface area of head-to-pillow contact and thus distributes pressure uniformly across the contact area uniform. Further, the greater the area of contact between the head and the pillow, the lower is the pressure on unit surface area of the head. The combination of these effects thus decrease the range of variation in pressure, and substantially diminish the occurrence of areas of focused pressure across the area of head-to-pillow contact that would occur with a conventional pillow or mattress.

Embodiments of the inflatable-pad typically have a substantially flat, sheet-like configuration that has a substantially equal depth across the surface ranging from the center to the periphery. Typical embodiments of the inflatable pad form a contiguous sheet. This configuration is supportive of a compliant conformability to the shape of an infant's head, and supportive of a resilient bias that encourages the inflatable pad to return toward a planar configuration in the absence of the weight of an infant's head. The bias to return toward a planar configuration prevents a problematic roll-off such as may occur if the infant's head were to be placed on the edge of the pillow, and it also generally maintains conformity to the infant's head as the head may shift during the time the infant is resting on an embodiment of the therapeutic pillow.

Structural features that underlie these qualities may include baffles within the inflatable region of the pad. Baffles generally serve to maintain the sheet like configuration of the inflatable layer and to compartmentalize fluid contained within the layer. One embodiment of a baffle system includes a star shaped pattern with a central fluid-region and an outside ring of fluid interconnected with fluid channels that re-distribute fluid uniformly. Another baffle embodiment may include a zigzag shaped baffle design that creates uniform pressure. Still another baffle embodiment may provide individual chambers interconnected by fluid channels forming patterned air pockets. The diameter of fluid connecting channels is optimized to fill adjoining air or fluid pockets more easily than over-filling each pocket.

FIG. 3C shows an exploded perspective view of layers of an embodiment of the inventive therapeutic pillow. As seen in FIG. 3C, the inflatable fluid-pad layer 39 may also include a port or opening 71 for injecting or removing fluid from the fluid-pad layer 39. In the case of air being used as a fluid, the port of aperture 71 will be sized for allowing easy injection and removal of air from the fluid-pad layer 37. One function of the inflatable fluid pad-layer 37 is to contribute to an ability to control the amount of the surface area of the head that contacts the pillow at any point in time. When the head is contact with the pillow, the fluid pad-layer cooperates with the pillow as a whole to form a pocket deep enough to allow a significant portion of the head surface area to be in contact with the pillow. Depending on the fluid pressure and/or volume in the fluid-pad layer 37, the percentage of surface area of the head in contact with the pillow can be controlled. Another function of the fluid pad layer is to uniformly distribute the pressure created due to the head around the entire contact surface area. The conformability of the fluid-pad layer 7 further contributes to the equal distribution of pressure across the portion of surface of the head that is in contact with the therapeutic pillow.

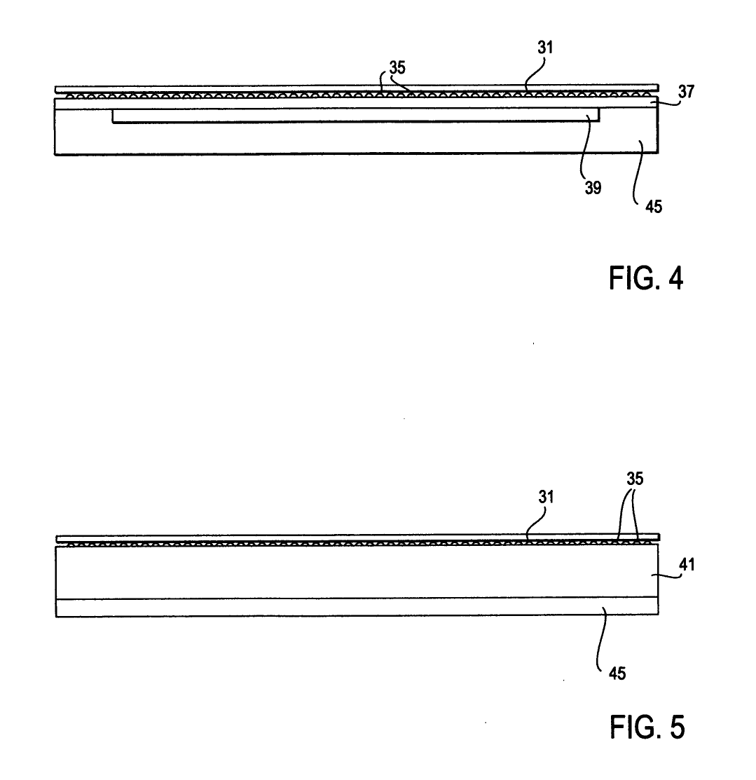

FIG. 4 shows an embodiment of a therapeutic pillow in which the base-foam layer 45 is wider than the fluid-pad layer 39, generally surrounding it peripherally. The base-foam layer 45 has raised sides to enclose the fluid-pad layer 39. The design prevents any roll-off effect or edge effect that could occur if an infant is placed near one end of the pillow instead of the center of the pillow. In some embodiments, the enclosing portion of base foam layer 45 may be about 10 mm to about 30 mm on each side of the fluid-pad layer 39.

FIG. 5 shows an alternative embodiment of a therapeutic pillow of the technology in which a pressure-pad layer and an inflatable fluid-pad layer are combined into a single integrated fluid-pad 41. The integrated fluid-pad 41 is disposed between the top layer 31 and bottom layer 45. The pressure pad layer may include a patterned arrangement of pressure-focusing elements as shown in FIGS. 6A-6C, or both top and bottom surfaces may be patterned. This integrated fluid pad 41 may be molded as one single piece by standard molding practices, and may include materials such as vinyl, rubber, silicone, or any suitable polymer. In some embodiments, a fluid-bag can be disposed within the integrated fluid to serve as a bladder for filling and removing fluid such as air or water from the integrated fluid pad. In some embodiments, the total thickness of the entire system after filling with fluid is may be between about 5 mm and about 2 cm.

FIGS. 6A, 6B, and 6C show various embodiments of a pressure-pad 37. FIG. 6A shows one embodiment of the pressure-pad 37 that is rectangular in shape. The pressure-pad 37 may include a patterned arrangement of pressure-focusing elements 35, such as pressure points or pressure-beads distributed thereon. In this embodiment, the pressure-beads are placed in a linear fashion such that each pressure bead is equidistant from any neighboring pressure-bead. The position of the pressure-beads 35 is such that any four pressure-beads in two adjacent rows or columns form corners of a rectangle or a square. The distance between two adjacent pressure-beads can vary from about 0.5 mm to about 1 cm. The height, or more generally, the diameter of pressure-beads 35 may vary from about 0.5 mm to about 1 cm. Pressure-beads may be spherical in shape or may be cylindrical in the bottom and tapered round towards the top. The pressure-beads 35 and an underlying base layer 33 may each be molded as one piece or can be made separately and then assembled into a single piece. The base layer 33 may have thickness varying from about 0.5 mm to about 5 mm. The material for pressure beads 35 and base 33 may include rubber, vinyl, silicone or any other suitable moldable plastic.

FIG. 6B shows another embodiment of the pressure-pad 37. In this embodiment, the pressure-beads 35 are arranged in a triangular pattern. Any three adjacent pressure-beads 35 in two adjacent rows form vertices of a triangle. FIG. 6C shows another embodiment of the pressure-pad 37. In this embodiment, the pressure-pad 37 may include flexible materials such as rubber, silicone, or any suitable polymer. In this embodiment, the pressure-focusing elements take a hill and valley form 36. The difference in elevation between the hills and valleys can vary from about 0.5 mm to about 1 cm. The top profile of the hill can be rounded to prevent any poking effect on the infant. The patterns described in FIGS. 6A, 6B, and 6C are merely examples of suitable patterns; other patterns that achieve the same purpose or functionality are included in the scope of the technology. Pressure-focusing elements may be associated with any embodiments of the technology described in this disclosure.

FIGS. 7A-7B show perspective views of an embodiment of a therapeutic pillow 10 that includes an outer shell 102 formed from vinyl, silicone, different types of rubber, or other similar material. Exterior shell 102 includes a port or opening 71 to allow air or any suitable gas composition to be inflated into the pillow. When the air is filled through port 71, the pillow provides support and conforms to a head resting thereon. The amount of air inflated into the inflatable layer may be adjusted to suit the comfort of therapeutic need of an individual user. An air valve may be in communication with port 71 to control influx and efflux of air. Baffles can be present inside of this pillow to prevent any roll off when an infant's head is close to a pillow edge. One such pair of baffles 75 is shown in FIG. 7B. Baffles can be formed of foam, rubber or any such material and may be present at any suitable location within the pillow.

Some embodiments of the therapeutic pillow may include separate compartments within the inflatable fluid pad such that pressure in various compartments may be independently controlled. In the case of an infant that has developed plagiocephaly, for example, a compartment of the inflatable pad that would support a relatively flat portion of the head would be inflated to a lower pressure, and a compartment of the inflatable pad that would support a disproportionately enlarged portion of the head would be inflated to a higher pressure. The difference in pressure within the inflatable compartments is reflected in the relative pressure exerted on the portion of the infant head resting on the therapeutic pillow. Such relative pressure difference comes, at least in part, from a reduction in the surface area (and consequent total pressure applied per unit surface area) of the therapeutic pillow that is in contact with the infant's head resting thereon.

Further, the relative difference in pressure in different sectors of the pillow can manifest in differences in the relative stiffness or compliance of the pillow. Thus, portions of a therapeutic pillow with relatively low pressure will be more compliant, and allow a deeper concavity within the pillow as the infant's head rests thereon. The combination of low pressure and deeper concavity encourages skull growth in the portion of the resting head. In contrast, the portion of the head that is resting on portion of the pillow with a higher pressure and with a lesser degree of concavity will be subjected to a resistance to growth.

Some embodiments of the technology include pressure-distribution elements within an enclosure such as an inflatable pad or within a breathable envelope. In these embodiments, the pressure-distribution elements are typically not in a fixed relationship with each other; they are rearrangeable or distributable. The ability of the elements to rearrange or distribute them selves in response to the pressure of a body portion contributes to their ability to distribute pressure. Pressure-distribution elements may be contained in baffled compartments, but they are generally unconstrained within such compartments.

FIG. 8 shows an embodiment of a therapeutic pillow that has an inflatable fluid-pad layer 39 containing a flowable medium or fluid 99, the inflatable layer disposed between an upper layer 31 and bottom layer 45. A plurality of solid pressure-distribution elements 61 such as beads are suspended or distributed within the fluid of the fluid-pad 39. Typically in these embodiments, the pressure distribution elements are substantially freely flowable against each other, and not physically constrained with regard to their movement within the fluid medium compartment. The distribution or frequency density of beads may vary within the medium, i.e., in terms of number of beads per unit volume of flowable medium. Further, the beads may vary in their volumetric or specific density, such that they may be either more dense than the fluid medium, of a density equal to that of the fluid medium, or that may be less dense that the fluid medium.

Fluid-pad 39 may have thickness varying from about 1 cm to about 3 cm. The beads 61 may be arranged in a random fashion inside of the fluid-pad 39. The fluid-pad 39 may be enclosed within a soft foam structure with the top foam layer 31 and bottom foam layer 45 forming the enclosing layers. The beads are typically spheroidal, with diameters ranging from 1 mm to 10 mm. The number of beads may vary and depend on the size of the bead and the size of the fluid-pad, and may be made from hard materials, such as plastics. In typical embodiments, the beads are substantially incompressible, however in some embodiments, the beads may be compressible or distortable to some extent.

When an infant sleeps on this pillow, the head weight will cause the beads 61 to rearrange conformably around the head and support the head at different pressure points while the fluid 99 is the substantial provider of back pressure to support the shape of the head and balance the head weight. The pressure or total volume of fluid 99 may be adjusted to allow for maximum head surface area to be supported. In some embodiments, the beads may be present at a sufficiently high volumetric presence with respect to the fluid volume within which they are distributed that they also contribute to the conformable support provided by the inflatable layer as a whole.

FIG. 9 shows a cross-sectional view of a compartment 113 an embodiment of a therapeutic pillow that includes a substantially porous or breathable surrounding layer 114, within which pressure-distribution elements 61 are disposed. The layer or compartment 113 may itself be enclosed in other layers, as described and depicted in other embodiments. The pressure-distribution elements 61 have features such as those described in the context of FIG. 8; i.e., they are typically hard, substantially incompressible, and move against and past each other without sticking, clumping, or otherwise interfering with the free movement of other pressure-distribution element. The overall porosity of the compartment 113, by virtue of substantially free influx and efflux of air, allows the pressure distribution elements to effectively bear a substantial portion of body weight pressure being applied to the pillow. The free movement or rearrangeability of elements 61 allows for a substantially equal distribution of pressure between the pillow and a body portion across an area of mutual contact between a body portion and the pillow surface.

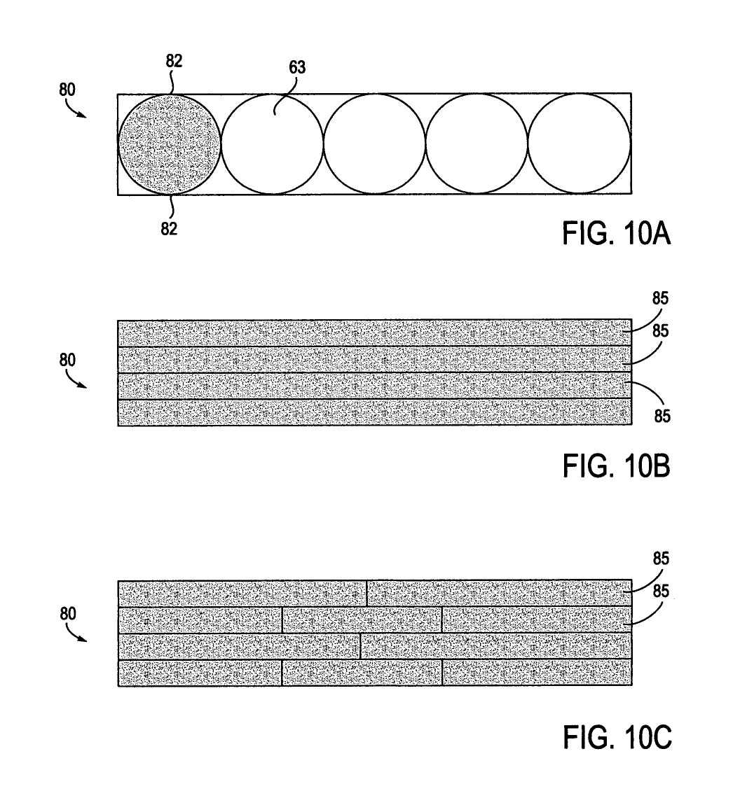

Some embodiments of the technology, as in the second group of embodiments summarized above, include pressure-distribution elements that are arrayed in a substantially fixed relationship with each other in a pattern. Examples of these embodiments are shown in FIGS. 10A-13C, as described in detail below. These pressure-distribution elements may be positioned in containers that are held in matrixed framework, the elements themselves may be held in position by attachment sites arranged in a pattern, or the elements may take the form of fluid filled containers arranged as a matrix, in a tiled manner. Pressure-distribution elements may be solid elements, such as beads, or they may be resilient vessels that are filled with a fluid composition. Fluid compositions may include gas, liquid, mixtures of gas and liquid, or gels. Pressure-distribution elements may be arranged as a monolayer or as multi-layered structures.

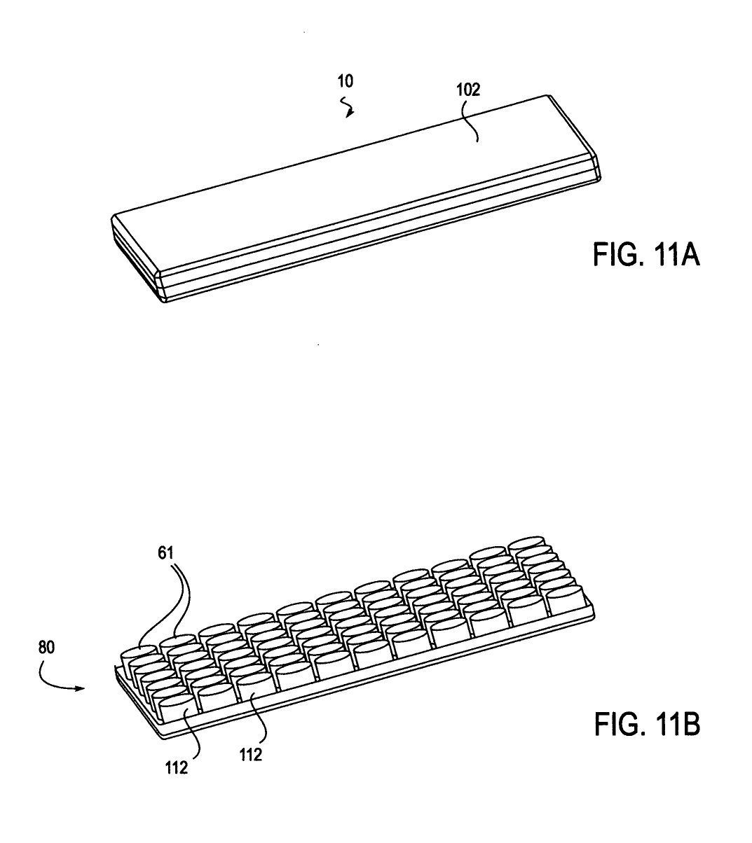

Some embodiments of the technology include pressure-distribution elements that arranged in an array such that they are in a fixed relationship with each other. In some embodiments, the array includes sites to which discrete pressure-distribution elements may be fitted into, or be attached to in any suitable manner. In other embodiments the array includes the elements, themselves, arranged in a fixed relationship without the particular sites of fixation or enclosure. FIGS. 10A-10C show examples of arrays of pressure-distribution elements. These embodiments are broadly similar to those described below and depicted in FIGS. 11A and 11B, but the presently described embodiments (as in FIGS. 10A-10C) may be understood as a matrix of attachment sites or fixation sites for pressure-distribution elements, rather than a matrix of containers, compartments, or capsules that hold pressure-distribution elements. Attachment of a pressure-distribution element to an attachment site within an array of attachment site may occur by any approach known in the art, such as by gluing, annealing, or any suitable form of adhesion or physical attachment.

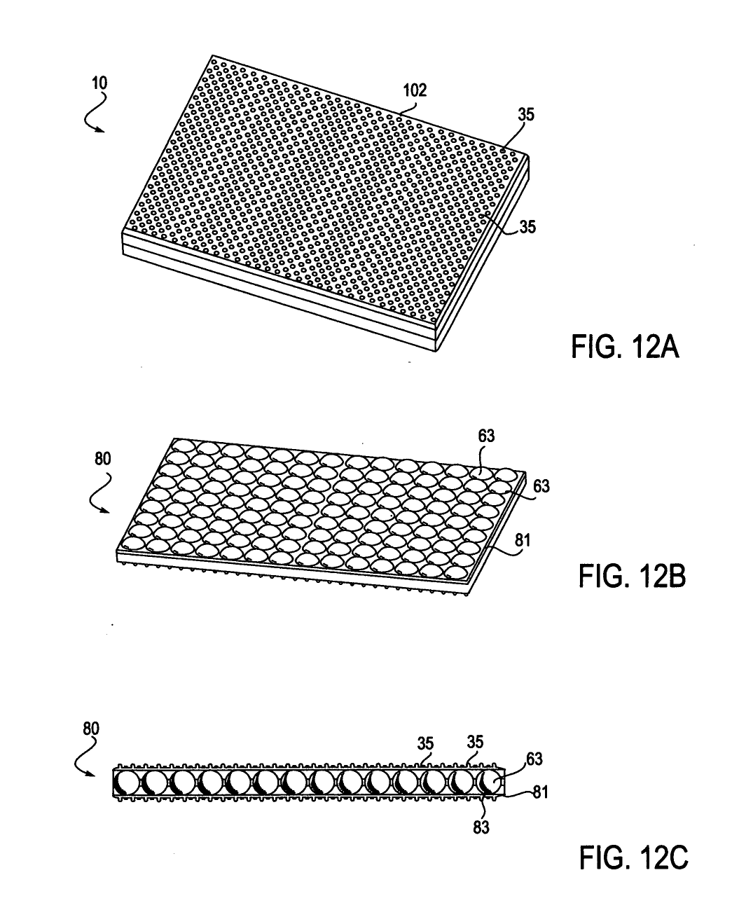

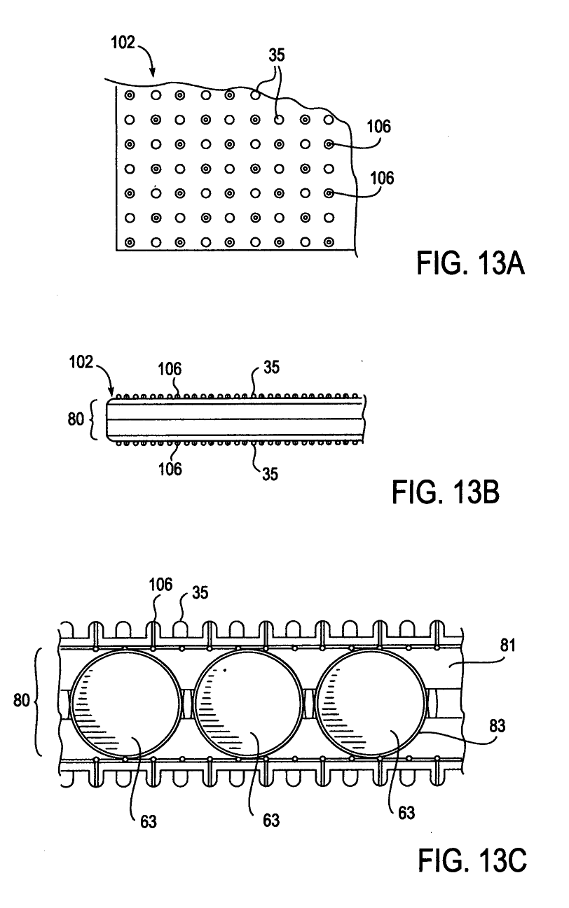

FIG. 10A shows a pressure distribution layer or compartment 80 of an embodiment of a therapeutic pillow that includes an array of attachment sites 82 to which fluid-filled pressure-distribution elements 63 may be fixed. FIG. 10B shows an embodiment of a therapeutic pillow that includes an array of one or more layers of tiled pressure-distributing elements or chambers 85 arranged in a pattern, each element having a fluid-filled space. The pattern shown in FIG. 10B is one such that the boundaries of the fluid-filled elements in the multiple layers are substantially aligned with each other. These tiled fluid filled elements 85 are similar to the spheroidal pressure-distribution elements 63 as seen in FIGS. 12B, 12C, and 13C in that they are both fluid filled, except that tiled elements 85 are connected together directly, rather than being arrayed in discrete cellular containers that are included in a matrixed framework or substrate. FIG. 10C shows an embodiment of a therapeutic pillow that includes an array of one or more layers of tiled pressure-distributing elements arranged in an alternative pattern, each element having a fluid-filled space.

As shown in FIGS. 11A and 11B, some embodiments of the technology include an array of cellular spaces or containers that are adapted to hold one or more pressure-distribution elements. These embodiments are similar to those described above and shown in FIGS. 10A-10C, but in contrast, the presently described embodiments, per examples shown in FIGS. 11A and 11B, include a framework that forms cellular spaces into which discrete pressure-elements may be disposed, rather than being attached or fixed to host sites. FIGS. 11A and 11B show examples of arrays of cellular spaces into which solid pressure distribution elements, such as beads may be disposed.

FIG. 11A shows a top perspective view of an embodiment of a therapeutic pillow that includes an array of cellular spaces (not visible in this view) in which pressure-distribution elements may be disposed. FIG. 11B shows an exposed top perspective view the embodiment; with the top removed, an array of cellular spaces in which pressure-distribution elements may be disposed. A pillow embodiment 10 includes an outside cover 102 comprising a breathable fabric composition such as wool, cotton, polyester, or any suitable blend. Outside cover 102 may also include non-fabric materials like vinyl, rubbers, although it is preferable for the fabric as a whole to breathable. As shown in FIG. 11B the pillow embodiment includes an array of independent containers 112 comprising a fabric or other suitable encasing materials such as silicone, vinyl of polyurethane. Containers 112 may be of any suitable cross sectional profile, such as spherical, or polygonal, and generally cylindrical in overall shape. Containers 112 are typically relatively closely packed in a generally area-filling pattern. When fully assembled, containers 112 are packed with solid pressure-distributing elements 61 such as beads, and closed in a manner sufficient to prevent substantial leakage of beads. In some embodiments, the material or fabric forming the containers is breathable, such that air moves freely though the container, thus allowing the pressure-distributing elements to bear pressure impinging on the device as a whole, as from a body portion resting thereon. In alternative embodiments, the material or fabric of the container may be either sealed in such a manner that air is trapped inside the container, or the fabric may be restrictive of airflow, such that air does not immediately escape when pressure impinges on the device as a whole. In these latter embodiments, air itself may be acting as a pressure-distributing agent, in addition to the pressure-distributing elements being held in the container.

As shown in FIGS. 12A-13C, some embodiments of a therapeutic pillow 10 may include an array of cellular spaces or containers that are adapted to hold a single fluid-filled pressure-distribution element 63 such as a fluid-filled spheroid. Inasmuch as fluids such as water are incompressible, embodiments of fluid-filled elements may be understood as being volumetrically-incompressible elements. These elements, though volumetrically incompressible, can be reduced in height by impinging pressure; such loss in height being compensated for by expansion in diameter. By such a dynamic, as described above in the summary section, these volumetrically-incompressible fluid filled elements can laterally distribute pressure.

FIGS. 12A-13C show examples a therapeutic pillow that include an array of cellular spaces into which fluid-filled pressure-distribution elements may be disposed. More particularly, FIG. 12A shows a top perspective view of an embodiment of the therapeutic pillow with internal pressure-distributing elements (not shown in this view) that further includes a surface having embedded pressure-focusing elements 35. FIG. 12B shows an exposed view pressure distribution layer 80 of the therapeutic pillow embodiment showing a matrixed substrate, or framework 81 that forms cellular spaces that accommodate fluid-filled pressure distribution elements 63. FIG. 12C shows a cross-sectional side view of an embodiment of the therapeutic pillow that includes a surface having pressure-focusing elements, and an array of cellular spaces into which fluid-filled pressure distribution elements may be disposed.

Typically, a single pressure distribution element is disposed within each cellular space, however embodiments of the technology include configurations whereby not every cellular space includes a pressure-distribution element, and in some instances, more than one pressure-distribution element may be disposed within a cellular space.

Outer shell 102, in which pressure-focusing elements 35 may be embedded, may be fabricated from elastic polymeric materials or plastics such as vinyl, rubbers and polyurethane, to name a few, merely by way of example. The outer shell fabric 102 may be constructed from suitable and breathable fabric-forming materials, as may include natural fibers such as cotton or wool, or synthetic fibers, or blends thereof. It is advantageous for the therapeutic pillow embodiment to be breathable, as a whole; i.e., such that air is able to move through the surface represented by outer shell 102. Thus, in the embodiments shown in FIGS. 12A-12C, the cover itself is substantially porous. Examples of therapeutic embodiments shown in FIGS. 13A-13C, as described below, provide internal channels and external ports that allow w influx and efflux of air. In these embodiments, external shell 102 may be relatively restrictive of air flux, as the system of channels and ports allows free influx and efflux of air.

FIG. 12B provides an exposed or internal view of a pressure distribution layer 80 of an embodiment of a therapeutic pillow, showing an array of cellular spaces within a matrixed framework or substrate 81, and with a fluid-filled pressure-distribution element 63 occupying each cellular space. The aspect dimensionality of such an array may take any suitable form. The framework 81 may be formed from different durometer silicone or polyurethanes, or from plastics such as vinyl. The pressure distribution layer may be of any suitable thickness for the therapeutic application; typical embodiments may vary in thickness from about 0.5 mm to about 10 mm. The pressure distribution layer of this embodiment includes a framework forming a matrix with cells or holes to hold the fluid spheres 63. The cells within the matrix may be circular or polygonal, and arranged in any suitable pattern, typically, a space-filling pattern. The diameter of the cell may be substantially identical, larger, or smaller than the natural diameter of the sphere 63.

FIG. 12C shows a cross sectional view of an embodiment of therapeutic pillow. As seen in the sectional view, the spheres 63 are disposed within cellular spaces 83 of a matrix or framework 81 of the pillow 10. Each sphere or spheroid 63 typically includes a silicone or polyurethane shell that holds a fluid such as water or silicone oil. The hardness of the silicon or polyurethane may vary in different embodiments. The diameter of sphere can be of any suitable dimension; in typical embodiments, the diameter is in the range of about 5 mm to about 5 cm. In some embodiments of the central layer, the population of the fluid-filled spheres is substantially homogenous, but in other embodiments, the population may be diverse with regard to any of the described properties. Further, although the overall shape of spheroids 63 is typically spheroidal by virtue of the natural shape of an elastic or deformable fluid filled article, embodiments of technology include variations from spheroidal, as may result from variation in thickness or composition of the spheroid across its surface. The matrixed aspect of a pressure distribution layer 80 may be understood as serving at least two purposes in the context of the disclosed technology; it may serve to control the percentage compressibility of fluid spheres 63, and may also serve to secure the fluid spheres 63 in place within a pattern.

FIGS. 13A-13C show embodiments of the therapeutic pillow that are similar to those shown in FIGS. 12A-12C, except that those in FIGS. 13A-13C have an air flow system comprising internal channels and ports or holes that communicate between the internal aspect of the pillow and the ambient environment. These embodiments may also include pressure-focusing elements, such as described above and shown in FIGS. 12A-12C.

FIG. 13A shows a top view of the surface of an embodiment of the therapeutic pillow that includes a surface having pressure-focusing elements 35 as well as pores or holes 106 for breathability between the exterior and interior of the pillow. FIG. 13B shows a side view of the surface of an embodiment of the therapeutic pillow shown in FIG. 13A. FIG. 13C shows a detailed cross-sectional side view of the surface of an embodiment of the therapeutic pillow that includes a surface having pressure-focusing elements as well as internal channels and pores for breathability between the exterior and interior of the pillow. In this view, breathability channels 107 are distributed internally within the pillow embodiment, forming conduits that communicate between internal space within the pillow, and the pores 106 that permit air influx and efflux. These holes 106 can be present among the pressure points 35 or on any other aspect of the surface of the pillow, including the sides. In addition to allow free flow of air between the inside of the pillow and the external environment in order to facilitate free expansion and compression of the pillow, this system of ports and internal channels allows an infant whose mouth or nose has come into contact with the pillow to breathe freely. The holes 106 may have a diameter of any appropriate and functional size, but typically vary from about 0.5 mm to about 5 mm. FIG. 13C also shows a detailed view of embodiments of fluid-filled distribution elements 63 enclosed within cellular spaces 83, the cellular spaces being arrayed within a matrix 81, the matrix being included within a pressure distribution layer 80.

Unless defined otherwise, all technical terms used herein have the same meanings as commonly understood by one of ordinary skill in the art of fabricating body support devices. Specific methods, devices, and materials are described in this application, but any methods and materials similar or equivalent to those described herein can be used in the practice of the present technology. While embodiments of the technology have been described in some detail and by way of illustrations, such illustration is for purposes of clarity of understanding only, and is not intended to be limiting. Various terms have been used in the description to convey an understanding of the technology; it will be understood that the meaning of these various terms extends to common linguistic or grammatical variations or forms thereof. It will also be understood that when terminology referring to devices or equipment, that these terms or names are provided as contemporary examples, and the technology is not limited by such literal scope. Some aspects of the theory by which embodiments of the technology have a therapeutic effect have been provided, such as the theory that the growing skull is responsive to pressure exerted thereon. These theoretical considerations are provided to facilitate an understanding of the technology, but have no relevance to or bearing on claims made to this technology. Moreover, any one or more features of any embodiment of the technology can be combined with any one or more other features of any other embodiment of the technology, without departing from the scope of the technology. For example, features described in the context of any one embodiment may be applied to any other described embodiment. Still further, it should be understood that the disclosed technology is not limited to the embodiments that have been set forth for purposes of exemplification, but is to be defined only by a fair reading of claims appended to the patent application, including the full range of equivalency to which each element thereof is entitled.

1. A personal support device for provision of therapeutic support to a portion of a body resting thereon, the device comprising:
a substrate comprising an array of one or more layers of pressure-distributing element host sites;
a population of volumetrically-incompressible pressure-distributing elements disposed at the arrayed host sites to form an array of pressure-distributing elements;
a therapeutic surface overlaying the pressure-distributing elements, the therapeutic surface positioned to interface between the array of pressure-distributing elements and an aspect of the body portion in contact with the therapeutic surface;
wherein the device is configured to form a supportive site within the therapeutic surface when the body portion is lying thereon, the site being conformative to the aspect of the body portion in contact with the therapeutic surface, the supportive site being further configured to apply a substantially uniform distribution of pressure against the aspect of the body portion in contact with the supportive site.

2. The personal support device of claim 1, wherein the supportive site is configured to be relocatable within the therapeutic surface area in response to movement of the body portion, the site configured to remain conformative to the aspect of the body portion in contact with the supportive site and to maintain a substantially uniform distribution of pressure against the aspect of the body portion in contact with the supportive site as the site relocates.

3. The personal support device of claim 1, wherein the volumetrically-incompressible pressure distributing elements comprise a volumetrically-incompressible flowable composition, and wherein the pressure distribution elements are sealed such that the flowable composition cannot flow between pressure-distributing elements.

4. The personal support device of claim 1, wherein the body portion is the head of an infant, the infant's head needing therapeutic support for the prevention or treatment of deformational growth, the device being sized and configured to support an infant's head.

5. The personal support device of claim 1, wherein the body portion is one that is in need of therapeutic support for the prevention or treatment a pressure sore, the device being sized and configured to support the body part.

6. The personal support device of claim 1, wherein the body portion comprises the whole of the body, the support device being sized and configured as a mattress or a pad that is sized and configured to overlay a mattress.

7. The personal support device of claim 1, comprising a plurality of layers of arrayed pressure-distributing element hosting sites, the sites of the layers in alignment with each other.

8. The personal support device of claim 1, comprising a plurality of layers of arrayed pressure-distributing element hosting sites, the sites of the layers in a staggered alignment with respect to each other.

9. The personal support device of claim 1, wherein the pressure-distributing elements are attached to the arrayed host sites.

10. The personal support device of claim 1, wherein the population of pressure-distributing elements comprises a population of fluid-filled cellular spaces.

11. The personal support device of claim 1, wherein the layer of arrayed pressure-distributing element hosting sites comprises a structural framework defining cellular spaces within the framework, and wherein the volumetrically-incompressible pressure-distributing elements are contained within the cellular spaces.

12. The personal support device of claim 11, wherein the framework comprises an elastomeric composition.

13. The personal support device of claim 1, wherein the population of pressure-distributing elements comprises fluid-filled spheroids.

14. The personal support device of claim 1, wherein the population of pressure-distributing elements comprises solid bead-like elements.

15. The personal support device of claim 13, wherein the fluid-filled spheroids comprise a liquid composition.

16. The personal support device of claim 13, wherein the fluid-filled spheroids comprise a gel composition.

17. The personal support device of claim 13, wherein the fluid-filled spheroids comprise a gas.

18. The personal support device of claim 13, wherein the fluid-filled spheroids are configured to be sufficiently compliant that they are partially flattenable when subjected to the weight of a body part lying on the therapeutic surface.

19. The personal support device of claim 13, wherein the fluid-filled spheroids comprise an elastomeric cover with sufficient resilience to return to the pressure-distributing element to a spheroidal shape upon relief from a flattening pressure.

20. The personal support device of claim 1, wherein the supportive site comprises a region within the therapeutic surface, such region overlaying a plurality of pressure distributing elements cooperating to conform to the body portion.

21. The personal support device of claim 1, wherein the pressure distribution elements are positioned in sufficiently close proximity to each other such that when pressure impinging on a first pressure-distribution element is sufficient to cause compression of the height of the pressure distribution element, such height compression is constrained by the lateral proximity of other pressure distribution elements adjacent to the first pressure-distribution element.

22. The personal support device of claim 1, wherein the pressure distribution elements are positioned in sufficiently close proximity to each other such that when pressure impinging on a first pressure-distribution element is sufficient to cause expansion of a diameter of the first pressure-distribution element, such expansion exerts lateral pressure on other pressure-distribution elements adjacent to the first pressure-distribution element.

23. The personal support device of claim 1, wherein the pressure-distributing elements, as disposed in the cellular spaces, have an uncompressed height that may be compressed by a weight of the body portion lying thereon to a compressed height by a fraction that ranges between a reduction to about 5% to about 95% of the uncompressed height.

24. The personal support device of claim 1, wherein the therapeutic surface is gas permeable.

25. The personal support device of claim 24, wherein a resilient layer underlays the gas permeable therapeutic surface, the layer sufficiently resilient to maintain a loft when an infant's head is laying thereon, the loft configured to provide air for the infant to breathe.

26. The personal support device of claim 1, further comprising a total exterior surface and wherein the total exterior surface defines an interior volume, the device further comprising internal channels configured to allow a passage of gas between the interior space and the ambient environment.

27. The personal support device of claim 26 further comprising a plurality of peripheral gas ports disposed at the exterior surface of the device, the ports connected to the internal channels.

28. A method for providing therapeutic support to a portion of a body comprising:
supporting the portion of the body on a therapeutic surface of the personal support device, the device comprising:
a substrate comprising an array of pressure-distributing element host sites;
a population of volumetrically-incompressible pressure-distributing elements disposed at the arrayed host sites to form an array of pressure-distributing elements;
a therapeutic surface overlaying the pressure-distributing elements, the therapeutic surface positioned to interface between the array of pressure-distributing elements and an aspect of the body portion in contact with the therapeutic surface;
wherein the device is configured to form a supportive site within the therapeutic surface, the site being conformative to the aspect of the body portion in contact with the therapeutic surface when the body part is lying thereon, the supportive site being further configured to apply a substantially uniform distribution of pressure against the aspect of the body part in contact with the supportive site.

29. A method for providing therapeutic support to a portion of a body, the method comprising:
forming a supportive site within a therapeutic surface that substantially conforms to an aspect of the portion of the body that contacts the therapeutic surface at a first location;
applying a substantially uniform distribution of pressure from the supportive site against the aspect of the portion of the body in contact with the therapeutic surface at the first location; and
relocating the supportive site from the first location to a second location within the therapeutic surface in response to the portion of the body shifting from the first position to a second position, the supportive site conforming to the portion of the body and applying a substantially uniformly distribution of pressure to the aspect of the body portion in contact with the therapeutic surface while the supportive site is relocating.
